(19) United States
(12) Patent Application Publication
(10) Pub. No.: US 2010/0020394 A1
(43) Pub. Date: Jan. 28, 2010

(54) CELESTIAL TRACKING DEVICE

(76) Inventor: Richard James Taylor, Bristol (GB)

Correspondence Address: Manelii Denison & Selter PLLC, 2000 M Street, 7th Floor, Washington DC, DC, 20036, US

(21) Appl. No.: 12/523,896

(22) PCT Filed: Jan. 23, 2008
(86) PCT No.: PCT/GB08/00210

§ 371 Date: Jul. 21, 2009

(30) Foreign Application Priority Data
Jan. 27, 2007 (GB) 0701605.8

(51) Int. Cl. G02B 23/16

(52) U.S. Cl. 359/430

(57) ABSTRACT

A celestial tracking device (10) for mounting an instrument thereon, the celestial tracking device (10) comprising first and second arms (12, 14) rotatably attached together at one end (13) and a drive means (20) rotatably connected between the other ends (15) of the first and second arms (12, 14) for relative rotation thereof between a home position and a deployed position. Advantageously, in the home position the drive means (20) is rotatable either clockwise or anticlockwise for use in the Northern or Southern hemispheres respectively. A further advantage is that the arms (12, 14) are stowed overlapping one another so that the device is compact and easily portable.

The present invention relates to a celestial tracking device for tracking the movement of celestial bodies, such as stars, planets and comets and for use with equipment for locating or recording, such as a camera or telescope, mounted thereto.

It is desirable to observe and record images of celestial bodies, such as stars, over a relatively long period of time to either improve image resolution or tracking of their relative movements to Earth. However, as the Earth rotates and/or moves relative to the celestial body it is necessary to rotate the optical device to counter the Earth's relative rotation and/or movement to present to the observation equipment a relatively stationary image of the body.

One conventional tracking mechanism is commonly known as a ‘barn-door tracker’ and comprises two stiff, thick plates, usually made from wood. The plates are hinged along one edge and driven apart by a screw thread that is rotated by hand or a motor. This mechanism must have its hinge axis directed at the North or South celestial pole to ensure correct tracking. In use the barn-door tracker is set up so that the plates are horizontal with the optical equipment mounted on the upper plate. However, this device is disadvantaged because the entire weight of the equipment is carried on the upper plate thereby loading a drive screw, which is required to be a highly precise component. As the device rotates the weight of the optical equipment changes on the drive screw and can cause inaccuracies in the tracking arc. Carrying such weight through the drive screw also means that a significantly sized motor and power supply is required. Further, as this mechanism is often manually carried to an observation site, away from night-time light pollution, these conventional mechanisms are further disadvantaged as they are both bulky and heavy. Yet another disadvantage is that the plates hinder a full range of movement of the camera or telescope etc on their mounting bracket.

It is therefore an object of the present invention to provide a more accurate, lightweight and easy to use celestial tracking device for mounting a camera, telescope, locating or recording equipment.

In accordance with the present invention there is provided a celestial tracking device for mounting an instrument thereon, the celestial tracking device comprising first and second arms rotatably attached together at one end and a drive means rotatably connected between the other ends of the first and second arms for relative rotation thereof between a home position and a deployed position, characterised in that in the home position the drive means is rotatable either clockwise or anticlockwise for use in the Northern or Southern hemispheres respectively.

Preferably, in the home position the first and second arms substantially overlap one another for compact stowage.

Preferably, in the deployed position the first and second arms define an angle up to +/−90 degrees.

Normally, in the deployed position the first and second arms define an angle up to +/−30 degrees.

Preferably, a screw guard is provided, the screw guard is rotatably mounted about the axis and is rotatable between the stowed and a second deployed position.

Optionally, the celestial tracking device comprises a locking means to secure the screw guard in a desired and second deployed position.

Preferably, the first and second arms and screw guard rotate in parallel planes.

Usually, the screw guard is arranged to carry a pole alignment device.

Usually, equipment is mounted to either the first or second arms.

Alternatively, the equipment is mounted near to the axis.

Normally, the optical device in any one of the group comprising a camera, telescope, locating equipment or recording equipment.

Preferably, the drive means is attached between the first and second arms at their distal ends from the axis.

Preferably, the drive means comprises a motor attached to one of the arms and a drive screw connected to the other arm.

Conveniently, the drive screw is screw thread and engages a cooperating feature on the other arm. The motor is rotatably mounted to the arm.

Preferably, the first and second arms are generally planar.

Preferably, the first and second arms are made from a material of any one or more of the group comprising a lightweight alloy, aluminium, titanium, carbon fibre or other reinforced plastic.

Preferably, the screw guard is stowed between first and second arms.

In another aspect of the present invention there is provided a portable celestial tracking device for mounting an instrument thereon, the celestial tracking device comprising first and second arms rotatably attached together at one end characterised in that in a stowed position the arms substantially overlap one another.

Importantly, the device comprises a drive screw attached to respective ends of the first and second arms and in the stowed position the drive screw is substantially parallel to the overlapping arms.

Preferably, the device comprises a screw guard; in the stowed position the screw guard is substantially parallel to and overlaps the arms.

Preferably, the device comprises shields and in the stowed position the shields are substantially parallel to and overlaps the arms.

The present invention will be described in detail with reference to the following drawings in which;

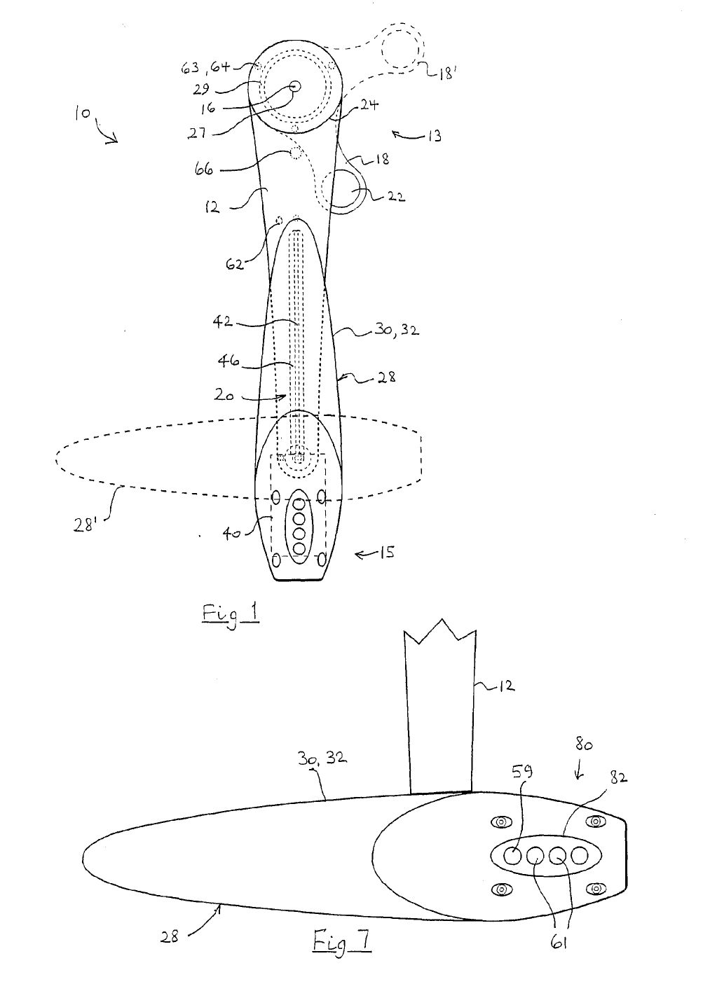

FIG. 1 is a plan view of a celestial tracking device in a stowed position for carrying or storage;

FIG. 2 is a is a plan view of the celestial tracking device in a deployed position;

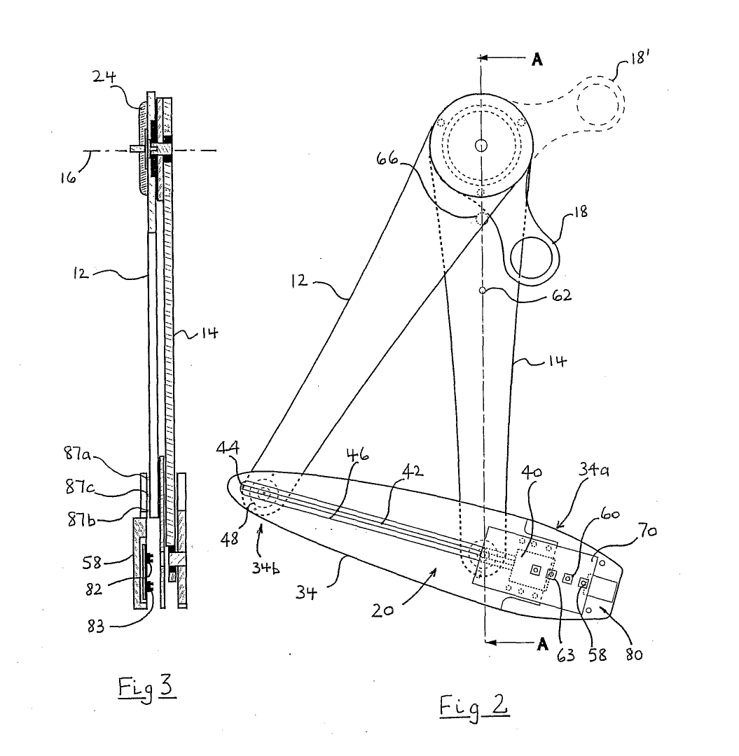

FIG. 3 is a cross-section A-A in FIG. 2 of the celestial tracking device, excluding its protective outer casing, in a deployed position;

FIG. 4 is an opposite side view to FIG. 2 of the celestial tracking device in its deployed position and showing its general arrangement and drive mechanism;

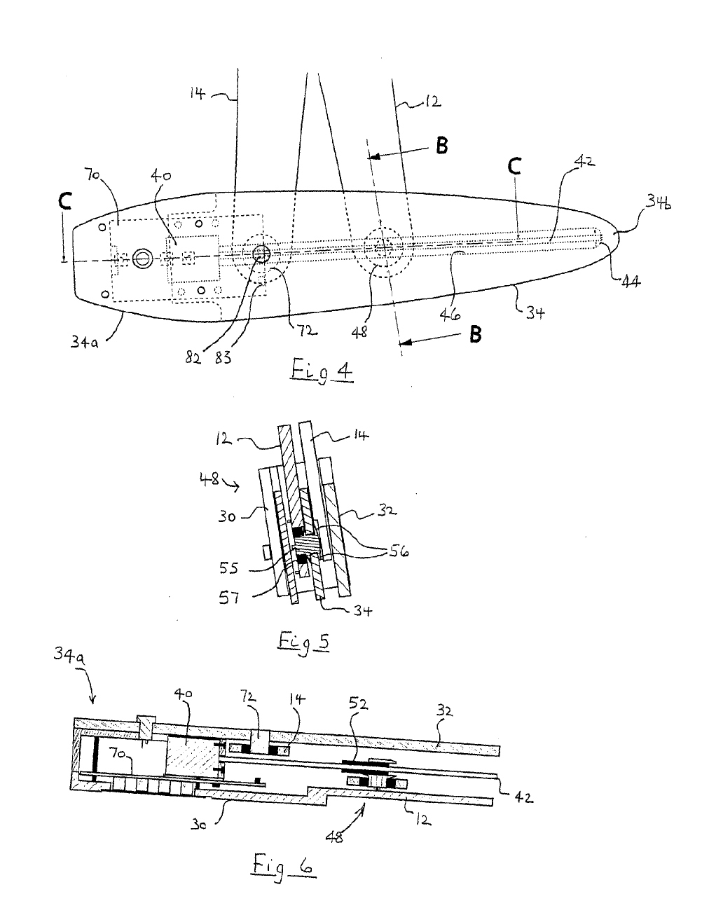

FIG. 5 is a cross-section B-B in FIG. 4 showing a preferred embodiment of a drive carriage assembly;

FIG. 6 is a cross-section C-C in FIG. 4 showing an alternative drive carriage assembly to FIG. 5;

FIG. 7 is a view of a protective casing surrounding the drive mechanism.

### General Configuration

Referring to FIGS. 1, 2 and 3, a celestial tracking device 10 comprises first and second drive arms 12, 14 rotatably mounted at one end 13 about a common axis 16, a polar arm 18 is also rotatably mounted about the axis 16 and a drive mechanism 20 that is attached between the first drive arm 12 and the second drive arm 14 at their other ends 15. The rotatable mounting comprises a pin 27 and bearing 29.

The celestial tracking device 10 also comprises a mounting plate 24 provided to carry optical equipment, such as a camera or a telescope, via a ball head joint, for example or other fixture as known in the art.

The drive mechanism 20 is housed in a casing 28 which is rotatably attached to the first arm 12 at its end 15. The casing 28 comprises outer shields 30, 32. The drive mechanism comprises a screw 42 driven by a motor 40. A screw guard 34 is located between the first and second arms 12, 14 and the screw 42 is situated within a slot 46 defined by the screw guard 34.

The polar arm 18 is adapted to carry a polar scope (not shown), which fits into aperture 22 at its other end. The polar arm 18 is rotatable independent of the first and second arms 12, 14.

### Drive Mechanism and Screw Guard

Referring now to FIGS. 4, 5 and 6. the drive mechanism 20 comprises a motor 40 driveably connected to a screw 42. In this example, the screw 42 extends to the motor 40 and forms its drive shaft. The motor 40 is mounted on a chassis 70 which itself is mounted to the screw guard 34 at a first end 34a. The screw 42 extends between the motor 40 and the second end 34b of the screw guard 34. The screw guard 34 is positioned between the drive arms 12, 14, however, the screw guard 34 may be positioned either side of the arms 12, 14. At the second end 34b, the screw engages in a support 44 mounted to or preferably integral to the guard 34b. This support 44 holds the screw 42 in position whilst allowing rotation. The support 44 comprises a simple ball or roller bearing; other bearings may be substituted without departing from the scope of the invention.

Conveniently, the screw 42 is situated in a slot 46 defined in the screw guard 34 and engages a drive carriage assembly 48 that is rotatably attached to the first arm 12 via a bearing 50. The screw 42 is generally in the plane of the screw guard 34 and therefore is protected from damage and also protects the user from harm, particularly from the end of the screw 42.

A nut 52, in the form of a tube with a threaded bore, presses into a hole through the drive carriage assembly 48. The drive carriage assembly 48 comprises a round section of bar 51 that can travel along the first arm's 12 bearing. This allows the second drive arm 14 to ‘float’ and reduces transmission of any wobble in the screw 42 to the second drive arm 14. Wobble transmitted to the second drive arm 14 can appear in images taken with the celestial tracking device 10 if the wobble amplitude is large compared to the image scale.

Alternatively, the drive carriage is pressed firmly into and may be adhered to the second arm's 14 bearing and therefore does not float. The flange on the carriage engages the screw guard 34 thereby suppressing wobble.

Referring to FIG. 6, the drive carriage assembly 48 comprises a sleeve 55 having flanges 54 that engage either side of the slot 46 of the screw guard 34. The sleeve 55 engages the first drive arm 12 via a bearing 57. The nut 52 tightly engages the sleeve 55 and does not rotate or move relative to the sleeve 55. The flanges 54 provide a close fit whilst allowing sliding and rotation of the sleeve 55 relative to the middle screw guard 34 and first arm 12. A bearing 57 is positioned between the first arm 12 and the sleeve 55, but may be omitted where low friction material are used instead.

When the screw 42 is driven the nut 52 is forced along the screw 42 and hence the drive carriage assembly 48 and first arm 12 is rotated away from or towards the second arm 14. This flange 54 and slot 46 guide arrangement helps prevent the drive carriage assembly 48 wobbling radially (with respect to the axis 16 in FIG. 1) as it travels along the screw 42 and in turn reduces transmission of wobble to the first drive arm 12.

Preferably, the sleeve 55 is made from plastics, which enables the drive carriage assembly 48 to be pressed together for tight fitting and has a low coefficient of friction to allow sliding and rotation where appropriate. Other materials may be used without departing from the scope of the present invention.

The screw guard 34 protects the screw 42 from accidental damage and protects the user, especially their eyes, from the end of the screw 42. The screw guard 34 is made from aluminium (or other suitable material) and is therefore relatively stiff and lightweight. The outer casings 30, 32 of the shield 28 are preferably made from plastics (or other suitable material) so that they have a degree of flexibility and are also lightweight. The plastic also allows light from an LED status indicator 60 to illuminate the shield 30, 32 so it can be seen in the dark.

An alternative drive carriage assembly 48 comprises a sleeve 55 without flanges 54, and has a small clearance between both edges of the slot 46 of the screw guard 34. The sleeve 55 engages the first drive arm 12 via a bearing 57. Otherwise this assembly 48 is configured and operates similar to the FIG. 6 embodiment.

### Polar Arm

The polar arm 18 rotates around the common or main drive axis 16 and allows the polar scope to align the celestial tracking device 10 with the North or South celestial poles for accurate tracking. The position of the polar arm is indexed every 15 degrees with three ball plungers 63 (FIG. 1), arrange 120 degrees apart, mounted in a top surface of the first drive arm 12 and engaging with depressions 64 formed in a facing surface of the polar arm 18.

The polar arm 18 can be rotated to a position which provides a clear view of the North or South Celestial Pole when the celestial tracking device 10 is loaded with equipment. The rotation also allows alignment of the polar scope to be checked parallel to the main drive axis 16 by adjusting setting screws on the polar scope. Such adjusting setting screws are well known in the art. The polar scope is also well known in the art and shall not be described further.

The polar arm 18 is limited to a rotation of less than 360 degrees, being prevented from rotating between the two stowed drive arms 12, 14 by a dowel 66 (see FIGS. 1 and 2) mounted in the top of the second drive arm 14. This results in part of the end of the polar arm 18 jutting out from between the drive arms 12, 14 when stowed, and therefore making it easy to pull the polar arm 18 out for use. The polar arm can be stowed in an anti-clockwise or clockwise direction. Advantageously, this arrangement also helps prevent the casing 28, drive mechanism 20 and screw 42 assembly being deployed in the direction that the polar arm 18 is stowed, thereby serving as a convenient reminder about the direction to deploy the drive means 20 and casing 28 for each hemisphere.

### Motor Chassis

Referring back to FIGS. 2 and 4 in particular, a motor chassis 70 supports the motor 40 and a driven or first arm spigot 72 which allows the motor 40, a printed circuit board 58 (PCB), casings 28, screw guard 34 and carriage assembly 48 to pivot as the arms 12, 14 open to maintain an isosceles triangle geometry.

It should be appreciated by the skilled artisan that although the exemplary embodiment herein describes the arms 12, 14 and screw forming an isosceles triangle, other triangular shapes are possible and the electronics described later merely require appropriate programming.

### Deployment

In the stowed position in FIG. 1, the casing 28 is generally parallel to the overlapping drive arms 12, 14. To deploy the celestial tracking device 10, the casing 28 and drive means 20 are driven in a clockwise or anticlockwise rotation depending on which hemisphere the user is in. The celestial tracking device 10 may be either deployed from the stowed position as shown in FIG. 1 or deployed from a position where the arms 12, 14 are fully ‘open’ as shown in FIG. 2. Here the arms are driven towards a ‘closed’ or stowed position shown in FIG. 1.

The celestial tracking device 10 is deployed for Northern Hemisphere use when the casing 28 is rotated anticlockwise and for Southern Hemisphere use in the clockwise direction. Note here that this clockwise and anti-clockwise deployment is a very advantageous aspect of the present invention as other tracking mounts require both software re-setting and/or exchange of hardware to achieve this. Some tracking mounts are incapable of such a change and may only be used in one Hemisphere or the other.

A ‘home position’ is referred to which is where the drive arms 12, 14 are closed and directly overlapping one another with zero angular separation as shown in FIG. 1. Two ball spring plungers 62 are mounted on the upper and lower drive arms 12, 14 and each engages a depression either side of the tip of the middle screw guard 34. These plungers give a positive position and click noise when the celestial tracking device 10 is moved to its stowed or home positions.

For a portable celestial tracking device, which is the preferred embodiment of this invention, the ability to stow in a compact configuration, when the shields 30, 32, 34, drive assembly 20 and arms 12, 14 are generally parallel and overlapping is particularly advantageous over the prior art devices.

In the deployed position, the arms 12, 14 are maintained in position by the weight of the shields 30, 32, the drive assembly 20 and the middle guard 34. The arms 12, 14 may alternatively be held in position by an interference or friction mechanism, such as a sprung ball and corresponding socket.

### Electronic Control

Referring to FIGS. 2 and 7, the celestial tracking device 10 comprises an electronic control 80 comprising a printed circuit board (PCB) 58 and a user interface 82 on the outside of the casing 28. The PCB 58 comprises at least one microprocessor 60 and other electronics, as known in the art, necessary to controlling the rate of the motor 40. The PCB 58 is commanded by a series of buttons 61 of the user interface 82 to carry out particular functions. In particular, one button is operable to begin tracking and another to re-set the arms 12, 14 in the home position, or the open position, ready to begin tracking again or for stowage.

Alternatively or as well as the user interface 82, the celestial tracking device 10 may be controlled via wireless remote control or a personal computer. The programmable control device (microprocessor, personal computer etc) controls the tracking rate, which is dependent on the changing geometry of the arms 12, 14 and screw 42 and the apparent angular velocity of the observed object. Thus the motor drives the screw 42 to move the arms 12, 14 apart at a constant or otherwise desired rate; the rate of rotation of the screw 42 being non-linear, but determinable via geometry by the skilled artisan.

A multi-colour light emitting diode (LED) 59 is provided to indicate the status of the tracking device 10. Alternatively, two or more single colour LEDs 59 may be used. An audio device 63 is also provided to give a warning of the status of the tracking device 10.

### Transmissive Photo Interrupters & Position Sensing

In FIG. 3 and dashed in FIG. 1 are shown two positional detectors, in this case transmissive photo interrupters 82, 83. The photo interrupters 82, 83 are connected to the electronics and are positioned to provide an indication of the position of the arms 12, 14, casing 28 and drive assembly 20. The two detectors 82, 84 are positioned on the underside of the PCB 58 which sense when a pin 87 passes the detector. There are three pins 87a, b, c two of which are either side of the second arm 14 bearing and the other in the centre of the carriage assembly.

The upper detectors 82 senses the central pin 87c where the arms 12, 14 are in the home position and are directly on top over one another (i.e. no angular separation). In the stowed position the central photo interrupter is oriented so its slot is parallel to the drive arms. When the celestial tracking device 10 is put into the North or South deployed position, the casing 28, motor 40 and PCB 58 assemblies rotate as one, aligning the slot 87a, 87b in the detector perpendicular to the drive arms 12, 14. This allows the central pin to clear the central detector as the arms 12, 14 open.

The outer photo interrupter senses the North and South deployed positions. The photo interrupter's beam is only broken by the two outer pins when in these positions and it is only in these positions that the photo interrupter's slot is perpendicular to the drive arms, allowing a pin to clear the outer photo interrupter.

### Operation

The microprocessor 60 is programmed so that when power is applied in the stowed position the red LED is lit indicating that the celestial tracking device 10 is not ready for use. When power is applied in the deployed or home positions the green LED is lit indicating the device 10 is ready to track. Applying power when the arms 12, 14 are open in a deployed position causes the celestial tracking device 10 to automatically reset the arms 12, 14 to the home position, by rewinding the screw.

As mentioned above, depending which way the casing 28 is rotated, for Northern or Southern Hemisphere use, the celestial tracking device 10 emits an audible beep or series of beeps and the status LED turns green as the arm 14 reaches its home position. The deployed and home positions of the arms 12, 14 are sensed by the associated detector 82.

To begin tracking the tracking button 61 is depressed. The status LED flashes or pulses green to indicate that the celestial tracking device 10 is tracking. The microprocessor commands the motor 41 to turn the screw 42 and driving the nut 52 and drive carriage assembly 50 along the screw 42, thereby opening the arms 12, 14.

In the last ten minutes, or other suitable duration, of tracking the celestial tracking device 10 emits an audible warning to signify that tracking is coming to an end and the green status LED flashes faster. Typically, after just over two hours, when the arms 12, 14 are just over 30 degrees apart, the celestial tracking device 10 audibly indicates such, tracking stops and the status LED turns red to indicate that tracking has ended. Pressing the rewind button causes the drive arms 12, 14 to close at a relatively high speed or to the open position for further tracking to begin. When the home position sensing photo interrupter beam is broken by the central pin, the motor 40 is stopped, and the status LED goes green to indicate that the celestial tracking device 10 is ready to track again.

The above description is an exemplary embodiment of the present invention and it should be appreciated that the skilled person may use alternative components known in the art without departing from the scope of the invention.

1-23. (canceled)

24. A celestial tracking device for mounting an instrument thereon, the celestial tracking device comprising:
first and second arms rotatably attached together at one end; and
drive means rotatably connected between the other ends of the first and second arms for relative rotation thereof between a home position and a deployed position, wherein the home position the drive means is rotatable either clockwise or anticlockwise for use in the Northern or Southern hemispheres respectively.

25. A celestial tracking device according to claim 24, wherein in the home position the first and second arms substantially overlap one another for compact stowage.

26. A celestial tracking device according to claim 24, wherein in a deployed position the first and second arms define an angle up to +/−90 degrees.

27. A celestial tracking device according to claim 24, wherein in a deployed position the first and second arms define an angle up to +/−30 degrees.

28. A celestial tracking device according to claim 24, wherein a screw guard is provided, the screw guard is rotatably mounted about the axis and is rotatable between the stowed and a second deployed position.

29. A celestial tracking device according to claim 28, wherein the celestial tracking device comprises a locking means to secure the screw guard in a desired and second deployed position.

30. A celestial tracking device according to claim 28, wherein the first and second arms and screw guard rotate in parallel planes.

31. A celestial tracking device according to claim 24, wherein observation equipment is mounted to either the first or second arms.

32. A celestial tracking device according to claim 24, further comprising an optical device selected from the group consisting of a camera, telescope, locating equipment or recording equipment mounted to either the first or second arms.

33. A celestial tracking device according to claim 24, wherein the drive means is attached between the first and second arms at their distal ends from the axis.

34. A celestial tracking device according to claim 24, wherein the drive means comprises a motor attached to one of the arms and a drive screw connected to the other arm.

35. A celestial tracking device according to claim 34, wherein the drive screw is screw thread and engages a cooperating feature on the other arm.

36. A celestial tracking device according to claim 34, wherein the motor is rotatably mounted to the arm.

37. A celestial tracking device according to claim 24, wherein the first and second arms are generally planar.

38. A celestial tracking device according to claim 24, wherein the first and second arms are made from a material of any one or more selected from the group consisting of a lightweight alloy, aluminium, titanium, carbon fibre or reinforced plastic.

39. A celestial tracking device according to claim 28, wherein the screw guard is stowed between first and second arms.

40. A portable celestial tracking device for mounting an instrument thereon, the celestial tracking device comprising:
first and second arms rotatably attached together at one end, wherein in a stowed position the arms substantially overlap one another.

41. A celestial tracking device according to claim 40, wherein the device further comprises a drive screw attached to respective ends of the first and second arms, in the stowed position the drive screw is substantially parallel to the overlapping arms.

42. A celestial tracking device according to claim 40, wherein the device further comprises a screw guard, and in the stowed position the screw guard is substantially parallel to and overlaps the arms.

43. A celestial tracking device according to claim 40, wherein the device further comprises shields and in the stowed position the shields are substantially parallel to and overlaps the arms.
